(19) United States
(12) Patent Application Publication
(10) Pub. No.: US 2024/0120756 A1
(43) Pub. Date: Apr. 11, 2024

(54) BATTERY CHARGER

(71) Applicant: MILWAUKEE ELECTRIC TOOL CORPORATION, Brookfield, WI (US)

(72) Inventors: Brijeshkumar K. Meghpara, Germantown, WI (US); Adam Sliwinski, Pewaukee, WI (US); Keith G. Koch, Kenosha, WI (US); Harold A. Morrow, JR., Waukesha, WI (US)

(21) Appl. No.: 18/479,309

(22) Filed: Oct. 2, 2023

Related U.S. Application Data
(60) Provisional application No. 63/426,635, filed on Nov. 18, 2022.
(60) Provisional application No. 63/414,756, filed on Oct. 10, 2022.

(51) Int. Cl. H02J 7/00; H01M 10/613; H01M 10/6563

(52) U.S. Cl. CPC H02J 7/0045; H01M 10/613; H01M 10/6563

(57) ABSTRACT

A battery charger includes a housing, electronic components, a longitudinal plane, a first fan, a second fan, and a lateral plane. The housing includes a connection interface to slidably receive a rechargeable battery. The electronic components are disposed in the housing. The longitudinal plane extends through the connection interface and the electronic components. The first fan is disposed laterally from the longitudinal plane in a first direction. The second fan is disposed laterally from the longitudinal plane in a second direction. The second direction is opposite the first direction. The lateral plane intersects the longitudinal plane. The lateral plane extends through the connection interface, the electronic components, the first fan, and the second fan.

### CROSS-REFERENCE TO RELATED APPLICATIONS

This application claims priority to co-pending U.S. Provisional Patent Application No. 63/414,756, filed on Oct. 10, 2022, and U.S. Provisional Patent Application No. 63/426,635, filed on Nov. 18, 2022, the entire contents of each of which are incorporated herein by reference.

### FIELD

The present disclosure relates to battery chargers for battery packs commonly used with power tools.

### SUMMARY

In one aspect, the present disclosure includes a battery charger according to embodiments disclosed herein. The battery charger includes a housing, electronic components, a longitudinal plane, a first fan, a second fan, and a lateral plane. The housing includes a connection interface to slidably receive a rechargeable battery. The electronic components are disposed in the housing. The longitudinal plane extends through the connection interface and the electronic components. The first fan is disposed laterally from the longitudinal plane in a first direction. The second fan is disposed laterally from the longitudinal plane in a second direction. The second direction is opposite the first direction. The lateral plane intersects the longitudinal plane. The lateral plane extends through the connection interface, the electronic components, the first fan, and the second fan.

In another aspect, the battery charger includes a housing, electronic components, and a fan. The housing includes a connection interface to slidably receive a rechargeable battery. The electronic components are disposed in the housing. The fan is disposed in the housing between the connection interface and the electronic components. The fan includes a centrifugal blower having an axis of rotation that extends through the connection interface and the electronic components.

In another aspect, the battery charger includes a housing, electronic components, and a fan. The housing includes a connection interface to slidably receive a rechargeable battery. The housing further includes a side wall. The connection interface extends along a longitudinal axis. The electronic components are disposed in the housing. The fan is disposed in the housing adjacent the side wall. The fan includes a centrifugal blower having an axis of rotation that extends transverse to the longitudinal axis. The axis of rotation extends between the connection interface and the electronic components.

Features and aspects of the disclosure will become apparent by consideration of the following detailed description and accompanying drawings.

### BRIEF DESCRIPTION OF THE DRAWINGS

FIG. 1 is a side elevation view of a battery charger and a battery pack with the battery pack removed from the battery charger.

FIG. 2 is a cross-sectional elevation view of the battery charger of FIG. 1 taken along the line 2-2.

FIG. 3 is the cross-sectional elevation view of FIG. 2 with an illustrated airflow path.

FIG. 4 is the cross-sectional elevation view of FIG. 2 with another illustrated airflow path.

FIG. 5 is the cross-sectional elevation view of FIG. 2 with another illustrated airflow path.

FIG. 6 is the cross-sectional elevation view of FIG. 2 with another illustrated airflow path.

FIG. 7 is a cross-sectional top plan view of the battery charger of FIG. 2 taken along the line 3-3 in FIG. 1.

FIG. 8 is a cross-sectional top plan view of a battery charger according to another embodiment of the disclosure.

FIG. 9 is a perspective view of the battery charger of FIG. 8 with a portion of a housing illustrated as transparent.

FIG. 10 is a cross-sectional elevation view of a battery charger according to another embodiment of the disclosure.

FIG. 11 is a cross-sectional elevation view of a battery charger according to another embodiment of the disclosure.

FIG. 12 is a cross-sectional perspective view of a battery charger according to another embodiment of the disclosure.

FIG. 13 is a perspective view of the battery charger of FIG. 12 with a portion of a housing illustrated as transparent.

FIG. 14 is a cross-sectional elevation view of a battery charger according to another embodiment of the disclosure.

FIG. 15 is a cross-sectional perspective view of the battery charger of FIG. 14.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting.

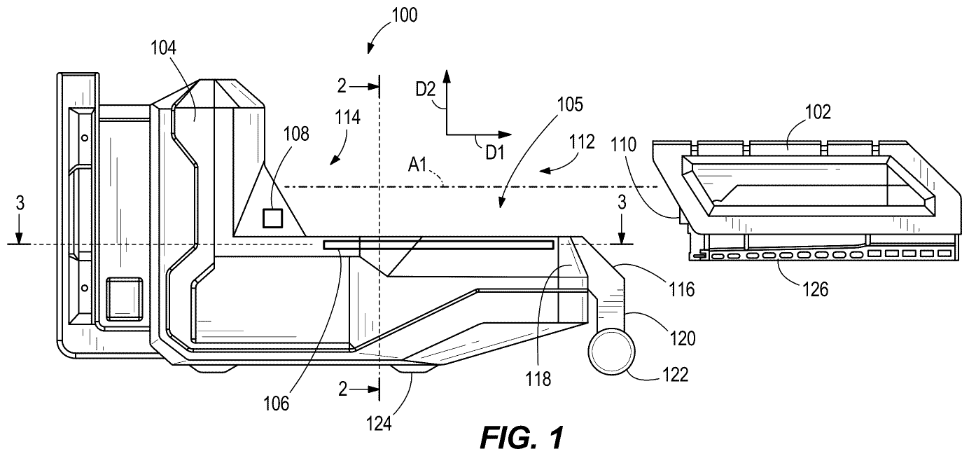

With reference to FIG. 1, an embodiment of a battery charger 100 is shown. The battery charger 100 is illustrated with a rechargeable battery 102 configured to be removably coupled thereto. The battery charger 100 includes a housing 104. The housing 104 includes a connection interface 105 having a connection rail 106. The connection rail 106 allows the rechargeable battery 102 to slidably couple to the battery charger 100 in a direction such as along a longitudinal battery sliding axis A1.

The battery charger 100 further includes charging terminals 108 configured to electrically couple with corresponding battery terminals 110 of the rechargeable battery 102. Upon sliding the rechargeable battery 102 along the connection rail 106, the battery terminals 110 of the rechargeable battery 102 contact the charging terminals 108 of the battery charger 100 when the rechargeable battery 102 is in an installed position. The rechargeable battery 102 is moved from a position remote from the battery charger 100 to the installed position by first entering a battery entry end 112 of a battery receiving area 114.

The battery receiving area 114 is defined by the housing 104. In the illustrated embodiment, the battery receiving area 114 is bordered on one side by the connection rail 106. Also, in the illustrated embodiment, the battery receiving area 114 is open in two perpendicular directions D1, D2 away from the housing 104. Engagement of the connection rail 106 with rechargeable battery 102, in the installed position, restricts movement of the rechargeable battery 102 relative to the housing 104 in the D2 direction. In some embodiments, the charging terminals 108 are disposed in the battery receiving area 114 opposite the battery entry end 112.

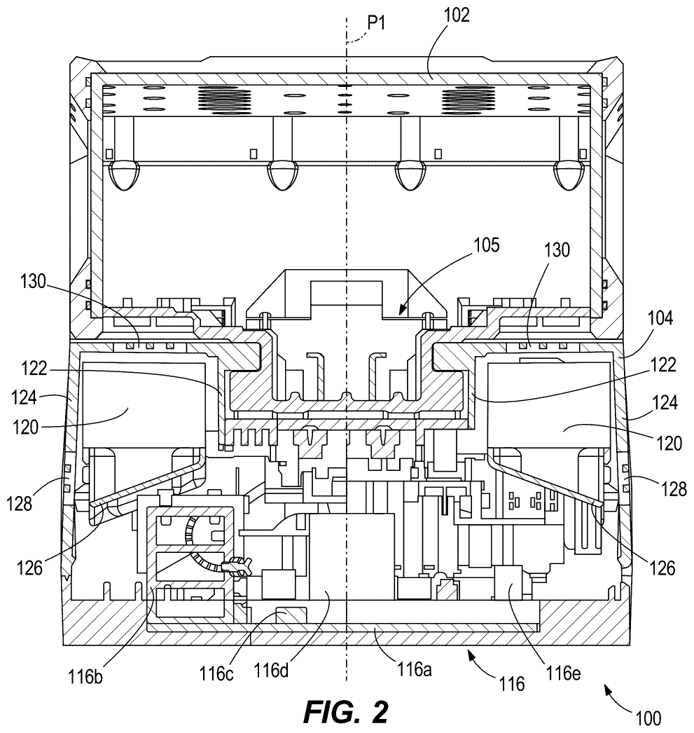

With reference to FIG. 2, the battery charger 100 includes electronic components 116 disposed in the housing 104. The electronic components 116 include a circuit board 116a and at least one other electronic component 116 disposed on the circuit board 116a. In the illustrated embodiment, the electronic components 116 also include a second electronic component 116b, a third electronic component 116c, a fourth electronic component 116d, a fifth electronic component 116e, and a plurality of additional electronic components 116. The electronic components 116 may include resistors, transistors, inductors, capacitors, or other electronic components. In the illustrated embodiment, a longitudinal plane P1 extends through the connection interface 105 and the electronic components 116. The plane P1 is an imaginary plane and generally divides the battery charger 100 into two symmetrical portions. Fans 120 are disposed within the housing 104 and are disposed laterally from the plane P1 and above the electronic components 116. In other words, the fans 120 are disposed in the housing 104 opposite the electronic components 116. The fans 120 are disposed between inner walls 122 of the connection interface 105 and side walls 124 of the housing 104. The fans 120 are also disposed adjacent side ducts 126, which are configured to guide air between the fans 120 and outside of the housing 104. The housing 104 includes side vents 128 on the side walls 124 and top vents 130 on a side 142 opposite the electronic components 116. The side vents 128 are located adjacent the side ducts 126, such that air flows between the side vents 128 and the side ducts 126. In some embodiments, the side vents 128 include a single vent on each of the side walls 124. In other embodiments, the side vents 128 include a plurality of vents disposed on each of the side walls 124. The side vents 128 may be aligned generally parallel with the longitudinal sliding axis A1, generally perpendicular to the longitudinal sliding axis A1, or in any other direction. The top vents 130 are located adjacent the fans 120 and the rechargeable battery 102, such that air flows between the fans 120 and the rechargeable battery 102 through the top vents 130 to cool the rechargeable battery 102. In one embodiment, the top vents 130 include a single vent. In other embodiments, the top vents 130 include a plurality of vents. The top vents 130 may be aligned generally parallel with the longitudinal sliding axis A1, generally perpendicular to the longitudinal sliding axis A1, or in any other direction.

In some embodiments, the fans 120, which may be axial fans as illustrated, are configured to direct air from the rechargeable battery 102, through the top vents 130 in a direction toward the electronic components 116, and into the fans 120. From the fans 120, the air is directed by the side ducts 126 in a direction away from the plane P1 and then exhausted through the side vents 128. In other embodiments, the fans 120 are configured to direct air into the housing 104 through the side vents 128 in a direction toward the plane P1 through the side ducts 126, and into the fans 120 in a direction away from the electronic components 116. From the fans 120, the air is then directed through the top vents 130 and into the rechargeable battery 102. In other embodiments, there are additional ducts between the fans 120 and the top vents 130. In any case, the fans 120, side ducts 126, side vents 128, and top vents 130 are configured in a cooling arrangement to cool the rechargeable battery 102.

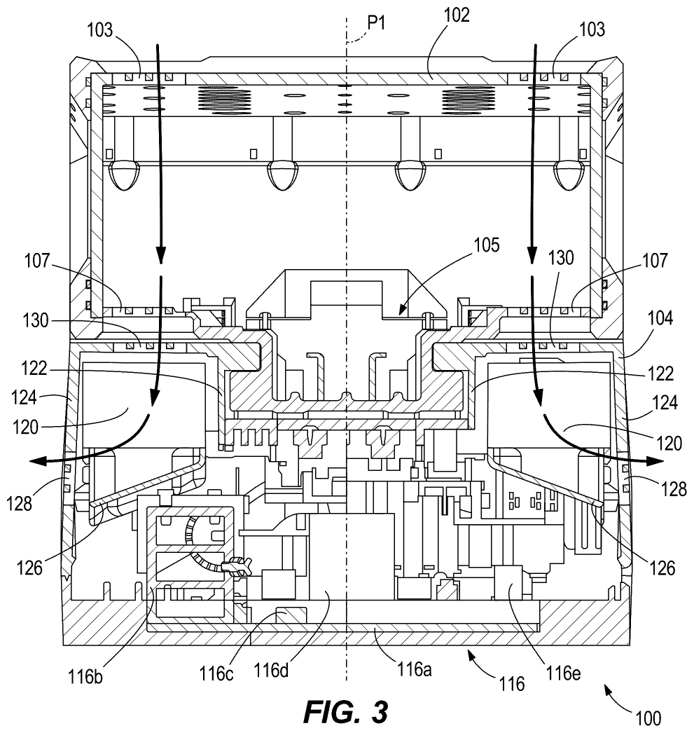

In some embodiments, air may be guided through the rechargeable battery 102 as well as the battery charger 100 when the rechargeable battery 102 is connected to the battery charger 100. As illustrated in FIG. 3, air may be directed into the rechargeable battery 102 through top battery vents 103 on a side of the rechargeable battery 102 opposite a connection interface of the rechargeable battery 102. The air may flow through the rechargeable battery 102 and then be directed through bottom battery vents 107 on the rechargeable battery 102 adjacent the top vents 130 in a direction toward the electronic components 116, and into the battery charger 100 through the top vents 130. The air may then flow out of the battery charger 100 in similar ways as in previous embodiments.

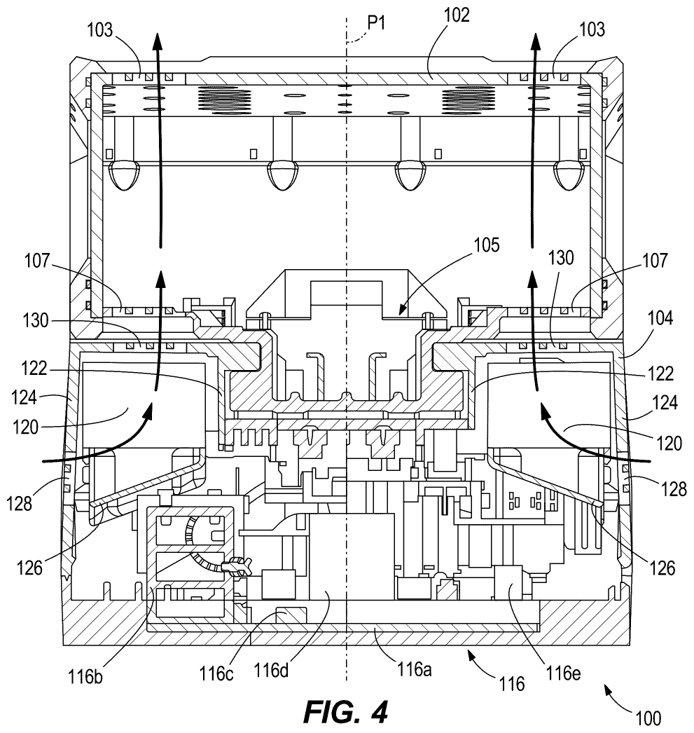

As illustrated in FIG. 4, air may enter the rechargeable battery 102 from the battery charger 100 through the top vents 130 and the bottom battery vents 107 in a direction away from the electronic components 116. The air may then flow through the rechargeable battery 102 and exit the rechargeable battery 102 through the top battery vents 103.

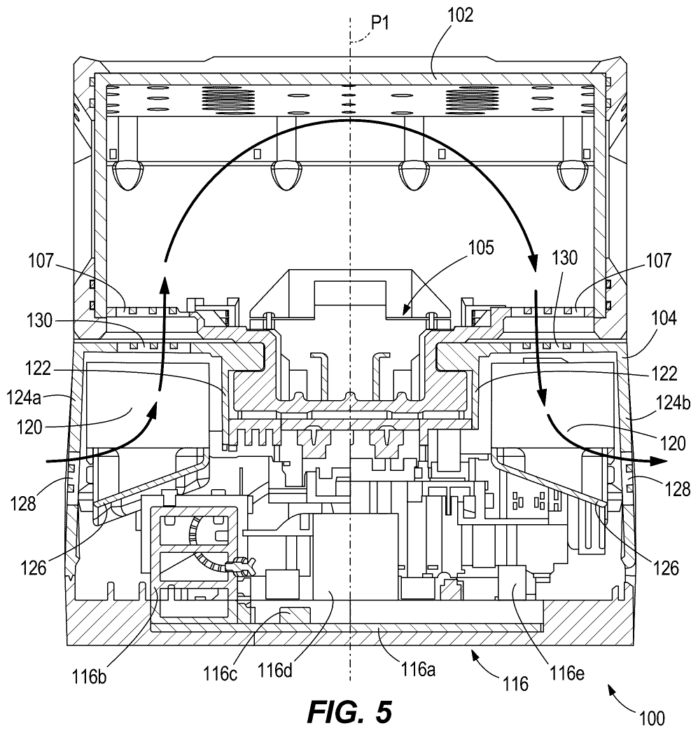

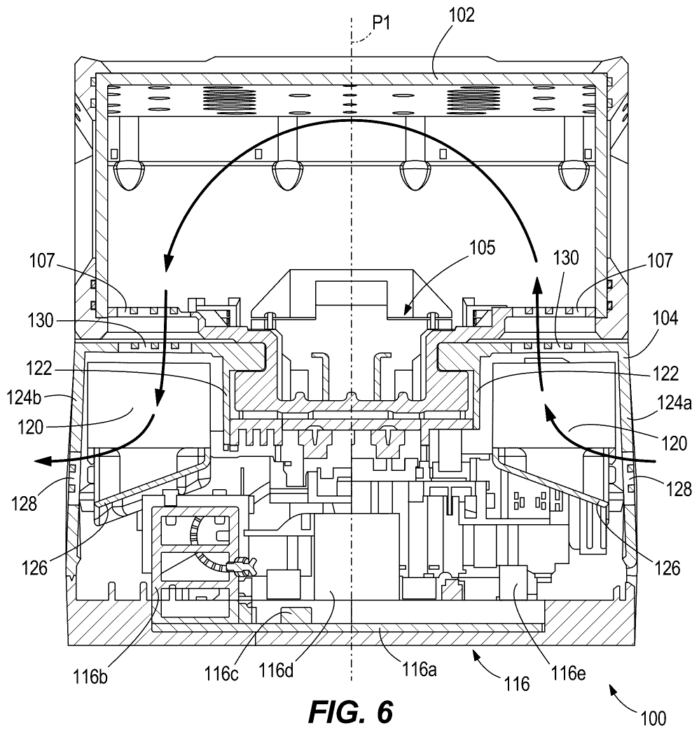

With reference to FIGS. 5 and 6, air may flow in a first side wall 124a of the battery charger 100, through the rechargeable battery 102, and then out a second side wall 124b of the battery charger 100 opposite the first side wall 124a. In some embodiments, air is drawn into the housing 104 through side vents 128 on the first side wall 124a in a direction toward the plane P1 through the side ducts 126 adjacent the first side wall 124a, and into the fans 120 adjacent the first side wall 124a. From the fans 120 adjacent the first side wall 124a, the air is directed through the top vents 130 adjacent the first side wall 124a, through the bottom battery vents 107 adjacent the first side wall 124a in a direction away from the electronic components 116, and into the rechargeable battery 102. The air is then directed through the rechargeable battery 102 and toward the bottom battery vents 107 opposite the first side walls 124a and adjacent the second side wall 124b. The air then flows through the bottom battery vents 107 adjacent the second side wall 124b, through the top vents 130 adjacent the second side wall 124b in a direction toward the electronic components 116, and into the fans 120 adjacent the second side wall 124b. From the fans 120 adjacent the second side wall 124b, the air is directed by the side ducts 126 adjacent the second side wall 124b in a direction away from the plane P1 and then exhausted through the side vents 128 on the second side wall 124b. FIG. 5 illustrates the airflow path in a first direction, and FIG. 6 illustrates the airflow path in a second direction opposite the first direction.

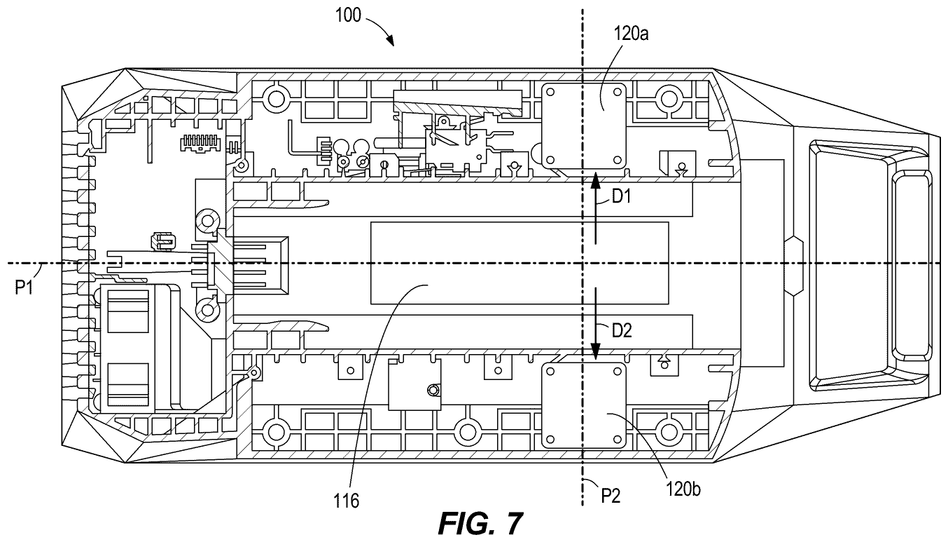

With reference to FIG. 7, the battery charger 100 includes two fans 120 that may be described as a first fan 120a and a second fan 120b. The first and second fans 120a, 120b are disposed on opposite sides of the plane P1. At least a portion of the connection interface 105 is disposed between the first and second fans 120a, 120b. The first fan 120a is disposed laterally from the plane P1 in a first direction D1, and the second fan 120b is disposed laterally from the plane P1 in a second direction D2. In the illustrated embodiment, D1 and D2 are perpendicular to the plane P1, and the direction D1 is opposite the direction D2, such that the connection of D1 and D2 defines a 180-degree angle. In other embodiments, the connection of D1 and D2 defines an angle different from 180-degrees. A lateral plane P2 intersects the first and second fans 120a, 120b, the connection interface 105, the electronic components 116, and the plane P1. The plane P2 is an imaginary plane. In the illustrated embodiment, the plane P2 perpendicularly intersects the plane P1. In other embodiments, the plane P2 intersects the plane P1 at a non-perpendicular angle.

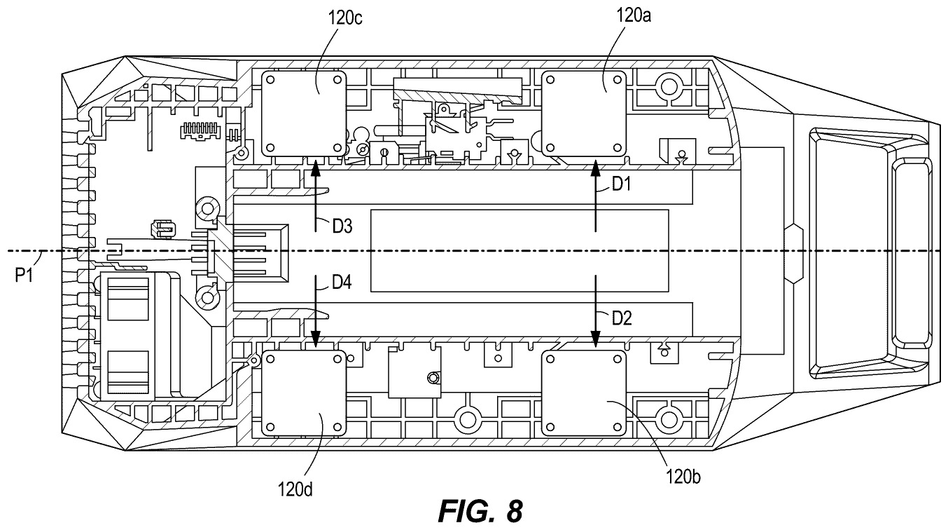

With reference to FIG. 8, the battery charger 100 includes four fans 120 that may be described as the first fan 120a, the second fan 120b, a third fan 120c, and a fourth fan 120d. The first fan 120a is disposed laterally from the plane P1 in the first direction D1, the second fan 120b is disposed laterally from the plane P1 in the second direction D2, the third fan 120c is disposed laterally from the plane P1 in a third direction D3, and the fourth fan 120d is disposed laterally from the plane P1 in a fourth direction D4. In the illustrated embodiment, the first direction D1 extends from the same side of plane P1 as the third direction D3, and the second direction D2 extends from the same side of the plane P1 as the fourth direction D4. In the illustrated embodiment, the first direction D1 is also parallel with the third direction D3, and the second direction D2 is parallel with the fourth direction D4. In other embodiments, the first direction D1 is not parallel with the third direction D3, and the second direction D2 is not parallel with the fourth direction D4. In the illustrated embodiment, the first fan 120a is aligned with the third fan 120c in a direction parallel to the plane P1. Similarly, the second fan 120b is aligned with the fourth fan 120d in a direction parallel to the plane P1. Though this embodiment includes four fans 120, the battery charger 100 may include any number of fans 120.

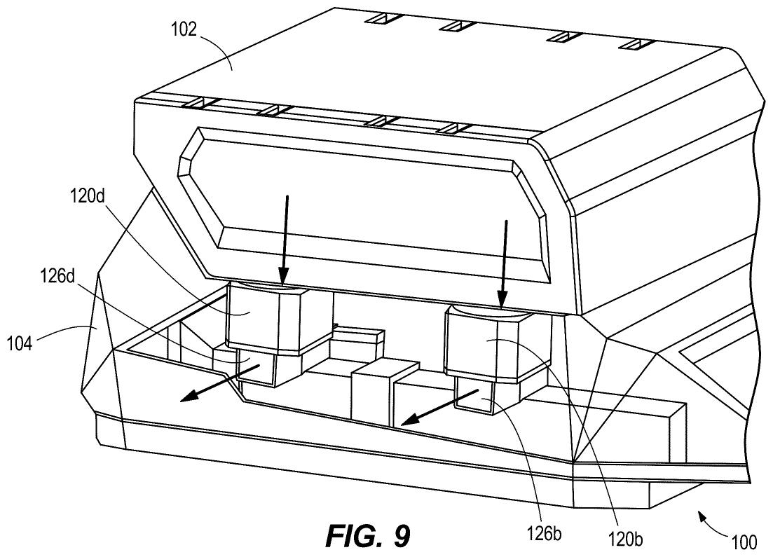

With reference to FIG. 9, the battery charger 100 includes four side ducts 126 that may be described as a first side duct 126a, a second side duct 126b, a third side duct 126c, and a fourth side duct 126d. The first side duct 126a is configured adjacent and fluidly coupled to the first fan 120a, such that the first side duct 126 guides air between the first fan 120a and outside of the housing 104. The other side ducts 126b-d are configured adjacent and fluidly coupled to the other fans 120b-d, respectively, to guide air between the fans 120b-d and the outside of the housing 104. In other embodiments, there are a plurality of fans 120 and a plurality of side ducts 126 configured to guide air between the plurality of fans 120 and the outside of the housing 104.

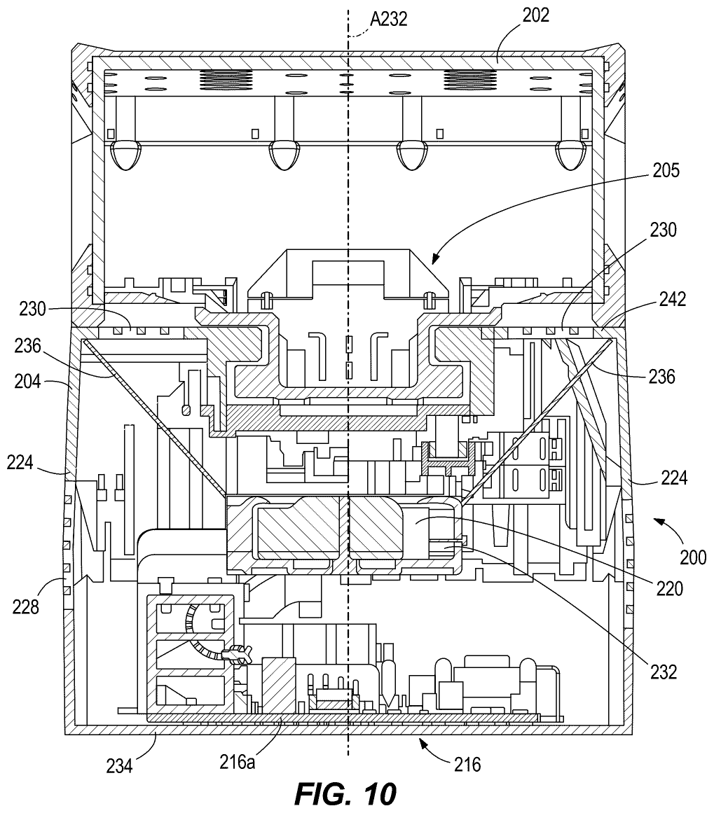

FIG. 10 illustrates another embodiment of the disclosure, with terms similar to FIGS. 1-5 labeled similarly plus a value of one hundred. The battery charger 200 may include any combination of features, dimensions, or range of dimensions from the preceding or subsequent embodiments, but only features of the battery charger 200 not yet discussed with respect to the previous embodiments are detailed below.

The battery charger 200 includes one fan 220 disposed between the connection interface 205 and the electronic components 216. The fan 220 includes a centrifugal blower 232 having an axis of rotation A232 extending through the connection interface 205 and the electronic components 216. The axis of rotation A232 is transverse to a side 234 of the housing 204 opposite the connection interface 205. In the illustrated embodiment, the axis of rotation A232 is also transverse to the circuit board 216a. In some embodiments, the axis of rotation A232 is perpendicular to the side 234 of the housing 204 opposite the connection interface 205, the circuit board 216a, or both. The centrifugal blower 232 is disposed adjacent a top duct 236 configured to direct air between the rechargeable battery 202 and the centrifugal blower 232. The top duct 236 may include a single duct or a plurality of ducts. In some embodiments, air flows into the housing 204 through top vents 230 in a direction toward the electronic components 216. The air is then guided by the top duct 236 into the centrifugal blower 232. From the centrifugal blower 232, air flows in a direction away from the axis of rotation A232 and exits the housing 204 through the side vents 228 disposed on the side walls 224. In other embodiments, air flows into the housing 204 through the side vents 228 in a direction toward the axis of rotation A232. The air then flows through the centrifugal fan 232 and flows out of the housing 204 in a direction away from the electronic components 216 through top vents 230.

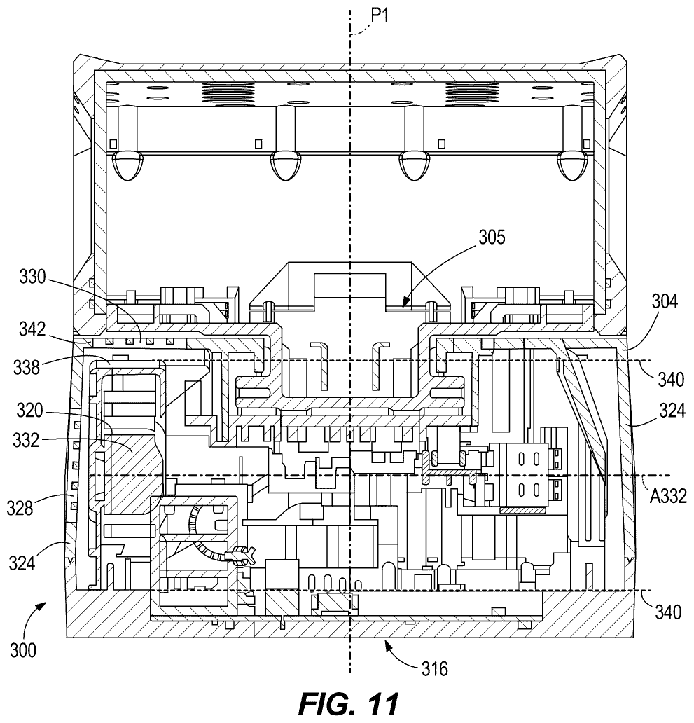

FIG. 11 illustrates another embodiment of the disclosure, with terms similar to FIGS. 1-5 labeled similarly plus a value of two hundred. The battery charger 300 may include any combination of features, dimensions, or range of dimensions from the preceding or subsequent embodiments, but only features of the battery charger 300 not yet discussed with respect to the previous embodiments are detailed below.

The battery charger 300 includes one fan 320 disposed in the housing adjacent the side wall 324 of the housing 304. The fan 320 may be disposed adjacent any side wall 324 of the housing 304. The axis of rotation A332 of the centrifugal blower 332 extends transverse to the plane P1. In some embodiments, the axis of rotation A332 extends perpendicular to the plane P1. The axis of rotation A332 extends between the connection interface 305 and the electronic components 316, such that the axis of rotation A332 does not intersect the connection interface 305 or the electronic components 316. The fan 320 defines a perimeter 338, and a projection 340 from the perimeter 338 extends parallel to the axis of rotation A332. The projection 340 is an imaginary projection and intersects the electronic components 316 and the connection interface 305. In some embodiments, air flows through the top vents 330 past the connection interface 305, in a direction toward the electronic components 316, and into the centrifugal blower 332. The air then flows out of the centrifugal blower 332 in a direction along the axis of rotation A332 and through side vents 328. In other embodiments, air flows from outside the housing 304 through side vents 328 in a direction along the axis of rotation A332 and into the centrifugal blower 332. The air then flows out of the centrifugal blower 332 in a direction away from the axis of rotation A332 and through top vents 330.

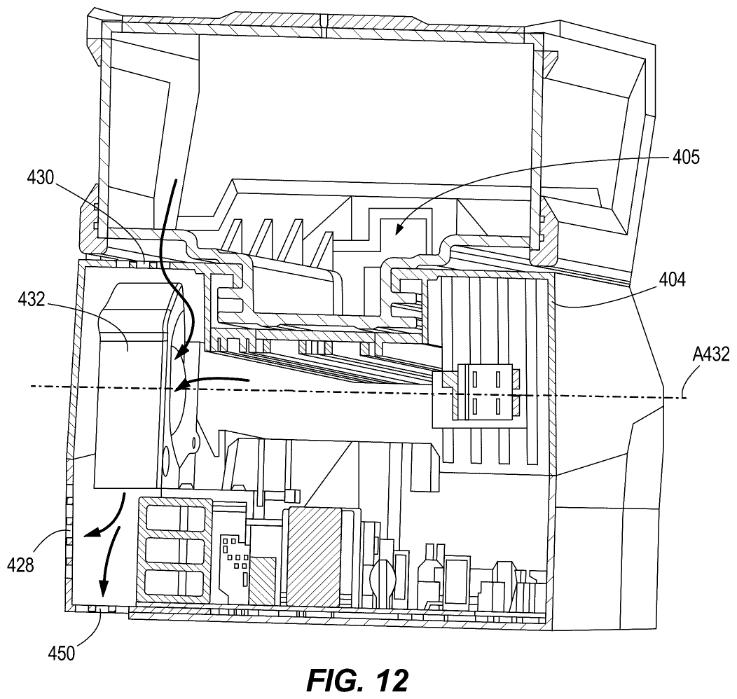

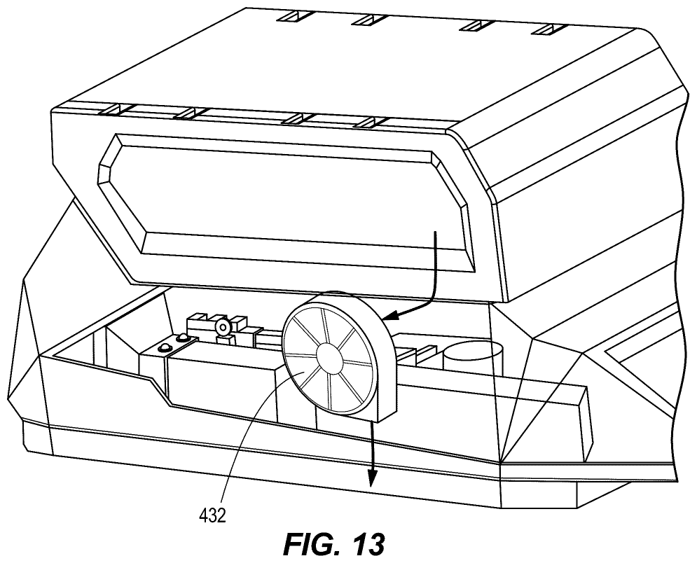

FIGS. 12 and 13 illustrate another embodiment of the disclosure, with terms similar to FIGS. 1-5 labeled similarly plus a value of three hundred. The battery charger 400 may include any combination of features, dimensions, or range of dimensions from the preceding or subsequent embodiments, but only features of the battery charger 400 not yet discussed with respect to the previous embodiments are detailed below.

Air flows through top vents 430 in the housing 404 past the connection interface 405 and toward the axis of rotation A432. Air then flows into the centrifugal blower 432 along the axis of rotation A432. The air then exits the centrifugal blower 432 in a direction away from the axis of rotation A432. The air may then exit the housing 404 through side vents 428, bottom vents 450, or a combination thereof. In some embodiments, the centrifugal blower 432 may be oriented such that air exits the housing 404 in any direction away from the axis of rotation A432, and the air is exhausted through vents on any side of the housing 404.

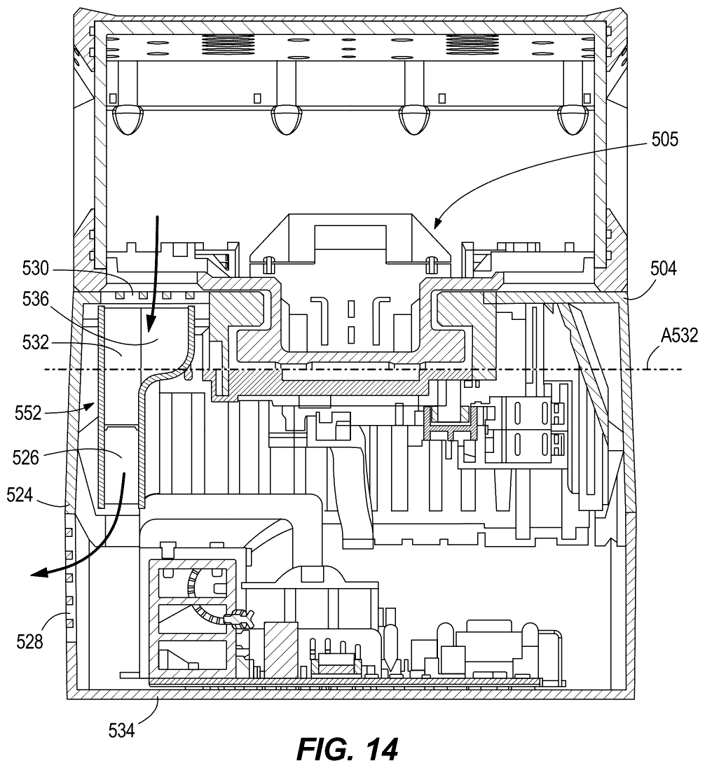

FIG. 14 illustrates another embodiment of the disclosure, with terms similar to FIGS. 1-5 labeled similarly plus a value of four hundred. The battery charger 500 may include any combination of features, dimensions, or range of dimensions from the preceding or subsequent embodiments, but only features of the battery charger 500 not yet discussed with respect to the previous embodiments are detailed below.

In this embodiment, the centrifugal blower 532 is disposed in a flow pathway of a duct system 552. The duct system 552 includes the side duct 526 and the top duct 536. The centrifugal blower 532 is oriented in the duct system 552 such that the axis of rotation A532 of the centrifugal blower 532 intersects the connection interface 505. The side duct 526 is disposed between the centrifugal blower 532 and the side 534 of the housing 504 opposite the connection interface 505. The top duct 536 is disposed between the centrifugal blower 532 and the connection interface 505. In some embodiments, the top duct 536 may be disposed between the centrifugal blower 532 and the side wall 524. As shown in the illustrated embodiment, the duct system 552 is a single unitary part, but other embodiments may include an assembly of ducts to form the duct system 552.

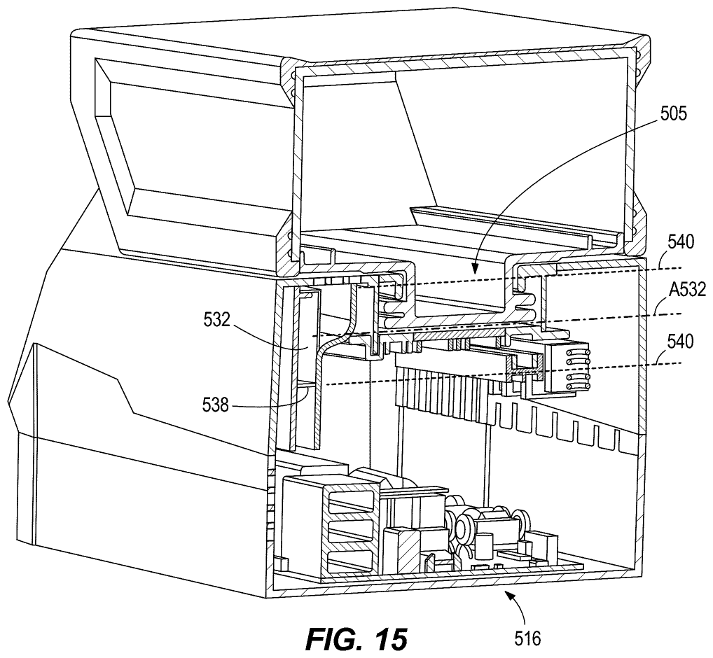

With reference to FIG. 15, the centrifugal blower 532 is disposed above the electronic components 516. Said another way, the projection 540 from the perimeter 538 of the centrifugal blower 532 does not extend through any of the electronic components 516. In some embodiments, the projection 540 extends through one or a plurality of the electronic components 516.

The disclosed embodiments are not limited in application to battery chargers. The same configurations may be applied to any number of power tools, equipment, power supplies, inverters, or lighting arrangements.

Various features of the disclosure are set forth in the following claims.

What is claimed is:

1. A battery charger comprising:
a housing including a connection interface to slidably receive a rechargeable battery;
electronic components disposed in the housing;
a longitudinal plane extending through the connection interface and the electronic components;
a first fan disposed laterally from the longitudinal plane in a first direction;
a second fan disposed laterally from the longitudinal plane in a second direction, the second direction being opposite the first direction; and
a lateral plane intersecting the longitudinal plane, the lateral plane extending through the connection interface, the electronic components, the first fan, and the second fan.

2. The battery charger of claim 1, wherein the electronic components include a circuit board and at least one other electric component disposed on the circuit board.

3. The battery charger of claim 1, wherein the first fan and the second fan are disposed in the housing opposite the electronic components.

4. The battery charger of claim 1, wherein the first direction and the second direction are perpendicular to the longitudinal plane.

5. The battery charger of claim 1, wherein the lateral plane perpendicularly intersects the longitudinal plane.

6. The battery charger of claim 1, further comprising a third fan and a fourth fan, the third fan disposed laterally from the longitudinal plane in a third direction, the fourth fan disposed laterally from the longitudinal plane in a fourth direction.

7. The battery charger of claim 6, wherein the first direction extends from the same side of the longitudinal plane as the third direction, and the second direction extends from the same side of the longitudinal plane as the fourth direction.

8. The battery charger of claim 1, wherein at least a portion of the connection interface is disposed between the first fan and the second fan.

9. The battery charger of claim 1, wherein the housing includes side walls with side vents defined therein.

10. The battery charger of claim 1, wherein air flows into the housing in a direction toward the longitudinal plane and exits the housing in a direction away from the electronic components.

11. The battery charger of claim 1, wherein air flows into the housing in a direction toward the electronic components and exits the housing in a direction away from the longitudinal plane.

12. A battery charger comprising:
a housing including a connection interface to slidably receive a rechargeable battery;
electronic components disposed in the housing; and
a fan disposed in the housing between the connection interface and the electronic components, the fan including a centrifugal blower having an axis of rotation that extends through the connection interface and the electronic components.

13. The battery charger of claim 12, wherein the electronic components include a circuit board and at least one other electric component disposed on the circuit board.

14. The battery charger of claim 13, wherein the axis of rotation of the centrifugal blower is transverse to the circuit board.

15. The battery charger of claim 12, further comprising a duct configured to direct air past the connection interface toward the centrifugal fan.

16. The battery charger of claim 12, wherein
the housing further includes a side wall having a vent defined therein, and
air flows into the housing in a direction toward the electronic components and exits the housing through the vent in a direction away from the axis of rotation.

17. A battery charger comprising:
a housing including
a connection interface to slidably receive a rechargeable battery, the connection interface extending along a longitudinal plane, and
a side wall;
electronic components disposed in the housing; and
a fan disposed in the housing adjacent the side wall, the fan including a centrifugal blower having an axis of rotation that extends transverse to the longitudinal plane, the axis of rotation extending between the connection interface and the electronic components.

18. The battery charger of claim 17, wherein a projection of a perimeter of the fan intersects the connection interface and the electronic components, the projection extending parallel to the axis of rotation.

19. The battery charger of claim 17, wherein
the side wall includes a vent defined therein, and
air flows into the housing past the connection interface in a direction toward the axis of rotation and exits the housing through the vent in a direction along the axis of rotation.

20. The battery charger of claim 17, wherein
the side wall includes a vent defined therein, and
air flows into the housing through the vent in a direction along the axis of rotation and exits the housing past the connection interface in a direction away from the axis of rotation.
